(19) United States
(12) Patent Application Publication
(10) Pub. No.: US 2026/0254629 A1
(43) Pub. Date: Aug. 27, 2026

(54) GEOLOCATION-BASED CONDITIONAL DATA DECRYPTION SYSTEM WITH ALTITUDE-ENHANCED SECURITY

(71) Applicant: TGrid Technologies Pty Ltd, Sydney (AU)

(72) Inventors: Santosh Devaraj, Bellevue Hill (AU); Arvind Manchenahalli, Nandini Layout (IN); John A Fortkort, Austin, TX (US); Sharansh Guha, Bengaluru (IN)

(21) Appl. No.: 19/448,089

(22) Filed: Jan. 13, 2026

Related U.S. Application Data
(60) Provisional application No. 63/744,749, filed on Jan. 13, 2025.

(51) Int. Cl. H04L 9/08

(52) U.S. Cl. CPC H04L 9/0872

(57) ABSTRACT

A method for conditional access to encrypted data based on geographic location is provided. The method includes generating an encrypted data file for secure information storage; associating the encrypted data file with a geolocation-based access condition, said access condition defined by a first set of geographic coordinates and a first altitude; generating and storing a unique access hash based on the access condition; receiving a request to decrypt the data file at a target location defined by a second set of geographic coordinates and a second altitude; generating a target location hash based on the target location; comparing the access hash and the target location hash; and decrypting the data file if the target location hash matches the access hash within a predefined threshold.

### CROSS-REFERENCE TO RELATED APPLICATIONS

The present application claims the benefit of priority from U.S. Provisional Application No. 63/744,749, filed on Jan. 13, 2025, which has the same title and the same inventors, and which is incorporated herein by reference in its entirety.

### FIELD OF THE DISCLOSURE

The present disclosure relates generally to the field of data security and access control, and more specifically to geolocation-based encryption and decryption systems that utilize geographic coordinates and altitude information to restrict data access to content to predefined physical locations.

### BACKGROUND OF THE DISCLOSURE

Geolocation-based access control systems use GPS-based geofencing to manage data access within specific geographic boundaries. These systems determine whether a user can encrypt, decrypt, view or interact with data based on their location, using GPS coordinates to enforce access permissions within defined areas.

Digital Rights Management (DRM) solutions provide access control over digital content, commonly using time-based restrictions to limit viewing periods or geofencing to restrict content to authorized regions. DRM technology is often applied to enforce licensing agreements, prevent unauthorized sharing, and control access to region-specific content.

Encryption systems with basic conditional access focus on securing data by verifying user identity through authentication methods such as passwords or biometrics. These systems enable or restrict access based on successful user verification, ensuring that only authenticated individuals can decrypt and access the protected information.

Location-based hashing techniques add an additional security layer to data encryption by generating keys tied to the user's physical location. By associating specific geographic coordinates with access keys, these systems provide a location-sensitive approach to encryption, creating keys that are valid only within designated areas.

### SUMMARY OF THE DISCLOSURE

In one aspect, a method is provided for conditional access to encrypted data based on geographic location. The method comprises generating an encrypted data file for secure information storage; associating the encrypted data file with a geolocation-based access condition, said access condition defined by a first set of geographic coordinates and a first altitude; generating and storing a unique access hash based on the access condition; receiving a request to decrypt the data file at a target location defined by a second set of geographic coordinates and a second altitude; generating a target location hash based on the target location; comparing the access hash and the target location hash; and decrypting the data file if the target location hash matches the access hash within a predefined threshold.

In another aspect, a system is provided for conditional access to encrypted data based on geographic location. The system comprises an encryption module configured to generate an encrypted data file for secure information storage; an access condition module configured to associate the encrypted data file with a geolocation-based access condition, said access condition defined by a first set of geographic coordinates and a first altitude; a hash generation module configured to generate and store a unique access hash based on the access condition; a location-determining module configured to determine a target location defined by a second set of geographic coordinates and a second altitude; a target location hash module configured to generate a target location hash based on the target location; a comparison module configured to compare the access hash with the target location hash; and a decryption module configured to decrypt the data file if the target location hash matches the access hash within a predefined threshold.

### BRIEF DESCRIPTION OF THE DRAWINGS

FIG. 1 is an illustration of a method for geolocation-based conditional data encryption and decryption with altitude-enhanced security enables data access exclusively within specific physical locations, using both geographic coordinates and altitude to verify the user's presence within a designated area.

### DETAILED DESCRIPTION

While geolocation-based access control systems effectively manage data permissions by geographic area, they often lack the precision required for highly specific environments. These systems typically use broad geofences, limited to latitude and longitude coordinates, which restrict access across large areas but cannot adequately distinguish, for example, between different floors or zones within a building. This broad approach makes it challenging to enforce fine-grained location-based security in complex, multi-level structures where access control within smaller zones or at specific altitudes may be required.

Similarly, Digital Rights Management (DRM) solutions, though widely used for content protection, face limitations in granular location control. Many DRM systems restrict content access based on large regional geofences or time-limited windows, yet they do not support fine-tuned geographic controls for confined spaces, such as individual rooms or specific areas within a larger facility. Additionally, without altitude-based verification, DRM solutions cannot enforce access control at a floor level in multi-story buildings, making them inadequate for applications that require precise location differentiation within a smaller geographic footprint.

Encryption systems with basic conditional access rely solely on authentication factors such as passwords or biometrics, providing security based only on user identity without consideration of physical location. Once authenticated, users can access data from any location, undermining security if data access is meant to be restricted to a specific environment. Moreover, these systems typically lack the capability for continuous, real-time location verification, meaning that users can move outside the intended secure zone without losing access to sensitive information.

Location-based hashing techniques add a layer of location-dependent encryption, but they generally generate location-sensitive keys only at the initial point of access. Without ongoing validation, these systems cannot enforce continuous location compliance, allowing users to relocate while retaining access to decrypted content. Additionally, these techniques do not incorporate altitude-based controls, limiting their effectiveness in settings where both horizontal and vertical location constraints are necessary for secure access. Consequently, current solutions in geolocation-based access, DRM, basic encryption, and location-based hashing fall short in providing the robust, precise, and adaptable controls needed for secure data management in complex, multi-level environments.

It has now been found that some or all of the foregoing problems may be addressed with the systems and methodologies described herein. Preferred embodiments of these systems and methodologies address these limitations by introducing a multi-dimensional geofencing mechanism that enables conditional access based on both geographic coordinates and altitude. By incorporating altitude data alongside latitude and longitude, the invention can restrict access to specific floors or zones within a multi-story building, offering a level of control that traditional geolocation systems lack. This allows organizations to enforce data access permissions within precisely defined areas, such as a particular room or floor within a secure facility, thereby enhancing security in complex environments.

In addition to location-based controls, preferred embodiments of these systems and methodologies provide continuous real-time validation, ensuring that access is restricted to users who remain within the designated secure zone for the entire session. Unlike standard encryption systems, which grant access once based solely on user authentication, this system requires ongoing compliance with both the geographic and altitude-based conditions, preventing unauthorized access if the user moves outside the permitted area. This continuous verification provides dynamic access control, making it well-suited for high-security applications where data should only be accessible within a confined space.

Preferred embodiments of these systems and methodologies further enhance security by incorporating multi-conditional access, allowing data availability to be limited not only by location but also by time or other contextual factors. For example, data can be made accessible only during specified hours or time windows, combining spatial and temporal access conditions. This flexibility is particularly useful for confidential meetings or time-sensitive content, where access must be controlled based on both location and timing. With these advancements, the invention overcomes the deficiencies of traditional geofencing, DRM, and encryption systems, providing a secure, adaptable, and precise access control solution for sensitive data in complex, multi-level settings.

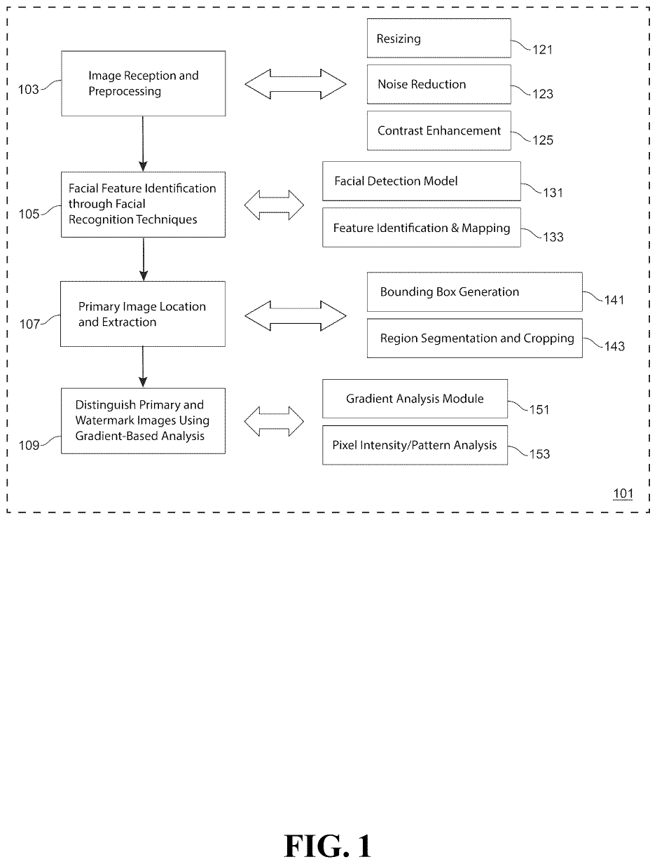

The systems and methodologies disclosed herein may be further understood with reference to the following particular, non-limiting embodiment which is depicted in FIG. 1. The method 101 depicted is for geolocation-based conditional data decryption with altitude-enhanced security enables data access exclusively within specific physical locations, using both geographic coordinates and altitude to verify the user's presence within a designated area. This embodiment requires a system that integrates various software and hardware resources to securely encrypt and decrypt data based on the user's precise location.

The process begins with the creation of an encrypted data file 103. A secure encryption module applies symmetric or asymmetric encryption algorithms 121 to generate an encrypted file for storage. For example, AES (Advanced Encryption Standard) can be used as a symmetric encryption algorithm for fast and secure data encryption, while RSA (Rivest-Shamir-Adleman) can provide asymmetric encryption for applications requiring public and private keys. To enhance security further, the encryption module may compress and digitally sign the data file 123 before encryption, ensuring its integrity and authenticity. Additionally, metadata can be stored 125 in the encrypted file to capture details about the encryption method, encryption key length, and geolocation-based access conditions. This step requires a processor capable of handling cryptographic operations, secure storage for encryption keys, a software library with support for cryptographic algorithms (e.g., OpenSSL), and compression and digital signature modules.

Once the file is encrypted, it is associated with specific geolocation-based access conditions 105. These conditions include altitude and latitude and longitude coordinates 131, and an optional radius or tolerance threshold. For example, access may be restricted to users located within a 5-meter radius on the 10th floor of a building. The access condition parameters are embedded 133 in the metadata of the encrypted data file, possibly encrypted as well, to prevent tampering. The access condition may also include environmental parameters, such as ambient temperature or time constraints, to further customize access control. This step requires a GPS receiver and altimeter for precise geographic and altitude data, suitable software to interpret GPS and altitude data and apply location-based access conditions, and secure storage for encrypted access condition metadata.

A unique access hash is generated 105 based on the specified geolocation conditions, ensuring that only users who meet these conditions can access the data. The hash combines specified geolocation conditions 141 such as the latitude, longitude, altitude, and other optional parameters (such as timestamp or device identifier) to create a unique identifier. Cryptographic functions 143, such as SHA-256, can be used to generate the hash, ensuring its security and immutability. The access hash is stored securely, possibly within a hardware security module (HSM) or a trusted platform module (TPM), to prevent unauthorized access. This step requires a cryptographic hash library (e.g., SHA-256) and secure hardware for hash storage, such as HSM or TPM.

When a user requests access to the encrypted data file 109, the system first verifies the user's location 151. Using location-determination hardware (e.g., GPS receiver and altimeter) and multi-factor authentication 153, the user's device determines its current location 155, preferably including latitude, longitude, and altitude. This information is then transmitted to the system as part of the decryption request. The system compares the current location with the access condition parameters, evaluating factors such as geographic proximity, altitude accuracy, and other environmental conditions. For added security, multiple location-determination technologies, such as Wi-Fi positioning or cellular triangulation, can confirm the coordinates and altitude. This step requires a GPS receiver, altimeter, and potentially additional location-determining technologies (e.g., Wi-Fi, cellular triangulation or magnetic GPS). It also requires a secure communication channel to transmit location and request data to the decryption system, and multi-factor authentication software to verify user identity.

Once the user's target location is verified, the system generates a target location hash 111 based on the current geographic location 161 (which typically includes coordinates, altitude, and other relevant conditions). This target location hash is created using the same parameters and hashing algorithm 163 (e.g., SHA-256) used to generate the original access hash. The result is a new hash unique to the user's current location, which will be compared against the stored access hash. This step requires a cryptographic hash library (e.g., SHA-256). It also requires a GPS and altimeter to provide accurate location data.

The system compares the stored access hash with the newly generated target location hash 113 to validate that the user's location matches the predefined access conditions 171. This comparison considers the tolerance parameters set during the initial configuration, allowing for minor deviations in location and altitude. If the access hash and target location hash match within the defined threshold 173 or defined geographic boundaries, the system proceeds to decrypt the data file. Any discrepancies in the comparison will prevent access, and an alert may be sent to an administrator in case of multiple failed attempts. This step requires hash comparison software to evaluate match between access and target location hashes. It also requires logging software to track access attempts and potential alerts for unauthorized attempts.

Upon successful verification, the system decrypts the data file 115 and makes it available to the user. The decryption key 181, which may be generated specifically for this session, is securely transmitted to the user's device. Additional security measures 183, such as time-limited access or periodic revalidation of the user's location, may be implemented to ensure the user remains within the secure zone throughout the session. The decrypted data may be streamed directly to the device to avoid storing it locally, or, if local storage is necessary, the data can be stored in a secure, encrypted format. The session automatically ends if the user moves outside the designated access zone, at which point the data is re-encrypted or access is terminated. This step requires decryption software capable of interpreting the encryption key and algorithm. It further requires secure key distribution software, potentially using public-key infrastructure (PKI) or secure communication protocols, and software to stream decrypted data or manage secure storage of the decrypted file.

The foregoing embodiment illustrates a robust, secure, and flexible method for enforcing geolocation-based data access, using precise geographic and altitude-based conditions, multi-factor authentication, and advanced encryption technologies to protect sensitive data. The system's hardware and software components ensure the data remains secure and accessible only within designated physical locations, making it well-suited for high-security environments.

Various modifications, additions and substitutions may be made in the systems and methodologies disclosed herein without departing from the scope of the present disclosure. Some of these modifications, additions and substitutions are described in greater detail below.

Various types of hash comparison software may be used in the systems and methodologies described herein. This software plays an important role in verifying that the target location hash generated from the user's current location matches the stored access hash within a defined tolerance, authorizing data decryption only when the user is in the designated location. Suitable software for this task includes OpenSSL, a widely used open-source cryptographic library that supports algorithms like SHA-256 for secure hash generation and comparison, making it highly adaptable for cross-platform implementations requiring real-time comparison. Bouncy Castle, another robust cryptographic library available in languages like Java and C#, provides extensive cryptographic support, enabling flexible hash functions and custom comparison methods tailored for proximity tolerances in geographic and altitude data.

Crypto++, optimized for performance and written in C++, is ideal for environments demanding fast, low-level hash comparisons, particularly in embedded systems where direct integration with hardware security modules (HSMs) is beneficial. For Windows-based systems, Microsoft's Cryptography API: Next Generation (CNG) integrates with Windows security and enables secure hash operations through built-in comparison functions, leveraging Windows Cryptographic Service Providers (CSPs) and offering secure key storage and hardware-backed security through trusted platform modules (TPMs). In cloud environments, AWS Key Management Service (KMS) combined with AWS Lambda provides a scalable, secure method to store access hashes and implement custom hash comparison functions. AWS KMS offers FIPS 140-2 compliance for secure storage, and Lambda enables flexible, adjustable tolerance comparison logic within Amazon's secure cloud infrastructure.

Lastly, Libgcrypt, a lightweight cryptographic library used in GnuPG, provides SHA-256 hashing and is particularly suited for embedded systems due to its efficient, low-level memory handling, which supports secure real-time hash comparisons. Each of these solutions offers strong cryptographic support and secure hash comparison functionality, making them suitable for verifying geolocation-based access conditions in the inventive data security system. The choice of software will depend on specific system requirements, such as platform compatibility, performance needs, and integration with other security modules.

In the inventive systems and methodologies for geolocation-based data decryption disclosed herein, cryptographic libraries play a crucial role in securing data through encryption, hashing, and digital signatures. OpenSSL, a widely-used open-source library, offers robust support for algorithms such as AES, RSA, and SHA, making it versatile and cross-platform compatible. This makes OpenSSL ideal for applications where secure encryption and location-based access controls are essential. Similarly, Bouncy Castle provides comprehensive cryptographic support across multiple languages, including Java and C#, making it especially suitable for Java and .NET applications requiring secure, multi-platform data handling.

For performance-critical environments, Crypto++ provides optimized C++ implementations of cryptographic algorithms, supporting fast, low-level control needed in embedded systems and real-time applications. In Windows-based systems, Microsoft's Cryptography API: Next Generation (CNG) integrates deeply with Windows security infrastructure, supporting hardware-backed security modules (HSMs) and providing secure cryptographic operations for enterprise applications. Google Tink offers a simplified, cross-platform cryptographic solution with broad algorithm support, ideal for mobile and cloud applications that need straightforward, reliable encryption.

For Linux or Unix-based systems, Libgcrypt provides an efficient, lightweight option that supports common cryptographic algorithms and is well-suited for resource-constrained environments. In cloud-native applications, AWS Key Management Service (KMS) delivers secure key management and cryptographic functions within Amazon's infrastructure, ensuring compliance and scalability for cloud-based data encryption and location-based access control. Each of these libraries enables secure data encryption and access control tailored to the system's platform and security needs, providing foundational cryptographic functions for enforcing geolocation-specific data access restrictions.

In the geolocation-based data decryption systems and methodologies described herein, processors capable of handling cryptographic operations are essential to efficiently perform secure tasks like encryption, decryption, and hashing. Intel Core processors with Intel Software Guard Extensions (SGX) provide secure enclaves for isolated cryptographic operations, making them ideal for enterprise and cloud applications where data security is especially important. For embedded and IoT devices, ARM Cortex-M series processors offer ARM TrustZone and CryptoCell technology, providing efficient, low-power cryptographic processing tailored to mobile or constrained environments. Similarly, AMD Ryzen Pro processors with the AMD Secure Processor (ASP) dedicate a security subsystem to cryptographic tasks, ensuring key management and encryption are isolated from main processing cores, enhancing security for geolocation-restricted data access in enterprise settings.

For industrial and automotive applications, NXP i.MX processors with ARM TrustZone and Crypto Engine deliver secure cryptographic functions in embedded environments, while Qualcomm Snapdragon processors with the Secure Processing Unit (SPU) excel in mobile devices, providing high-performance encryption and biometric authentication to reinforce location-based access. IBM POWER processors are designed for high-performance computing in data centers, offering cryptographic acceleration suitable for large-scale geolocation encryption systems requiring high throughput.

Apple's A-Series and M-Series processors, featuring a Secure Enclave, are well-suited for secure key storage and cryptographic tasks on Apple devices, ensuring robust protection for mobile and desktop geolocation-based systems. Finally, Xilinx Zynq UltraScale+ MPSoCs combine programmable logic with ARM cores, allowing for hardware-accelerated cryptographic operations and making them ideal for tailored, high-security implementations in industrial applications. Each processor offers unique cryptographic features, ensuring secure and efficient data handling across diverse deployment environments based on platform compatibility, performance needs, and specific security requirements.

Various types of secure storage for encryption keys may be utilized in the systems and methods described herein. In these systems and methodologies, securely storing encryption keys is typically essential to prevent unauthorized access. A variety of secure storage solutions are well-suited for this purpose, each offering unique benefits depending on the system's security needs and environment. Hardware Security Modules (HSMs) provide high levels of physical security by isolating keys from the main system and meeting stringent standards like FIPS 140-2. These devices are commonly used in high-assurance environments, such as banking or government systems, as they offer tamper-resistance and secure key destruction features, ensuring encryption keys remain protected.

For device-level security, Trusted Platform Modules (TPMs) serve as specialized chips that securely store cryptographic keys on the user's device, making TPMs ideal for use in the inventive method. They keep keys safe in the hardware and support secure operations, preventing keys from exposure to the main system memory. Similarly, secure enclaves, like Intel's Software Guard Extensions (SGX) or ARM's TrustZone, isolate cryptographic processes within a secure area of the processor, adding protection against software attacks by keeping keys separate from the main operating system.

In cloud-based environments, Key Management Services (KMS) offered by providers like AWS, Google Cloud, and Microsoft Azure provide robust, managed key storage. These solutions integrate with cloud services, allowing for flexible scaling and role-based access control, ideal for applications needing geographically restricted key access. Encrypted filesystems and secure software modules (such as Microsoft's Encrypted File System and Linux's eCryptfs) provide a software-based solution, which encrypts data at the filesystem level, adding a layer of security to systems that may lack dedicated hardware.

For mobile and edge applications, Trusted Execution Environments (TEEs), such as Apple's Secure Element or Samsung Knox, offer secure storage areas on mobile devices where cryptographic keys are protected within a secure area of the processor, isolated from the primary OS. For users requiring physical security, smart cards and USB security tokens (e.g., YubiKey) provide physical key storage, ensuring that only those with physical access to the token can decrypt data. Each of these secure storage options supports the inventive method's need for protecting encryption keys within tightly controlled geolocation and altitude-based access conditions, enabling flexible and highly secure storage solutions tailored to the application's specific needs.

In the systems and methodologies for geolocation-based conditional data decryption which are disclosed herein, compression modules are often essential for minimizing the size of encrypted files, enhancing storage efficiency, and improving transmission speeds. A variety of compression algorithms can serve this purpose, each tailored to different performance needs. zlib, an open-source library using the DEFLATE algorithm, balances compression ratio and speed, making it highly compatible across platforms and suitable for applications requiring real-time data access. Similarly, LZ4 prioritizes speed over compression ratio, allowing rapid compression and decompression, ideal for performance-critical applications like edge computing, where fast data retrieval is key.

For applications needing high compression ratios without regard for processing speed, bzip2 and LZMA are excellent choices. bzip2 achieves higher compression through the Burrows-Wheeler transform and Huffman coding, which is beneficial for securely storing large files over extended periods. LZMA, known for its high efficiency in compressing large files, is suitable for handling extensive secure data storage needs, especially in cloud-based or archival environments. Zstandard (Zstd) provides flexible compression settings, allowing systems to adjust compression based on storage needs and network conditions, balancing high performance and adaptability.

When rapid compression is essential, Snappy offers a solution focused on fast processing speeds with a modest compression ratio, ideal for systems where data retrieval speed is prioritized over size reduction. Xz, another LZMA-based compression module, compresses files to very small sizes, making it suitable for applications where storage savings are important, though at the cost of slower speed. Each of these modules provides unique strengths, allowing the inventive system to tailor compression solutions to meet specific requirements, such as maximizing storage, enabling fast access, or optimizing for various system environments.

In the inventive geolocation-based data decryption system, digital signature modules are essential for verifying data authenticity and ensuring that only authorized users can access encrypted content. A variety of digital signature solutions provide this security, each suitable for different system requirements. OpenSSL is a popular, open-source library that supports RSA, ECDSA, and DSA algorithms, making it a versatile choice for cross-platform applications needing reliable, scalable digital signing. For Java or .NET environments, Bouncy Castle offers extensive cryptographic support, allowing secure integration of digital signatures in software-driven geolocation systems.

On Windows, Microsoft Cryptography API: Next Generation (CNG) provides native digital signature support and secure key management, making it ideal for enterprise applications requiring system-level security. In cloud-based environments, AWS Key Management Service (KMS) and AWS CloudHSM enable scalable, FIPS-compliant digital signing, particularly useful for cloud-native systems with geolocation-controlled data access. Java Cryptography Architecture (JCA), with its built-in digital signature framework, is tailored for Java-based applications, including Android, providing efficient and secure data authentication.

For Linux-based or embedded systems, Libgcrypt delivers lightweight, low-level cryptographic functionality, suitable for resource-constrained devices needing robust digital signatures. Google Tink offers a straightforward, cross-platform solution that supports RSA and ECDSA, making it ideal for mobile and cloud applications that require easy-to-implement security. Each of these digital signature modules contributes to secure, tamper-proof data verification within the inventive system, ensuring encrypted data remains authentic and accessible only within authorized geolocations. The choice of module depends on the platform, performance, and security infrastructure needs of the application, providing adaptable solutions for diverse deployment environments.

In the geolocation-based data decryption systems and methodologies disclosed herein, reliable GPS receivers and altimeters are vital for capturing precise location and altitude data to enforce location-based access controls. High-performance GPS modules like the u-blox NEO-M8N and Quectel L86 provide multi-GNSS support (covering GPS, GLONASS, Galileo, and BeiDou), ensuring robust positioning even in challenging environments, with the NEO-M8N excelling in urban settings and the compact, low-power L86 ideal for portable devices. For applications demanding rapid location fixes, the SkyTraq Venus838FLPx offers high sensitivity, working effectively even in areas with weak signals. Additionally, the Broadcom BCM47755 provides dual-frequency support for GPS L1 and L5 bands, which improves accuracy in complex, urban landscapes-perfect for multi-story access control in dense city environments.

Accurate altitude measurements are equally essential for altitude-specific access control in multi-floor buildings. Sensors like the Bosch BMP388 and STMicroelectronics LPS22HH are widely used in mobile and IoT devices, offering high-resolution, power-efficient altitude readings suitable for continuous monitoring in secure access systems. The TE Connectivity MS5611 barometric sensor is known for its precise altitude tracking, which can be useful in dynamic environments such as drones or aviation, where altitude-specific security is crucial. For applications requiring integrated location and altitude data in one compact module, the Honeywell HMC5883L offers GPS, altimeter, and magnetometer capabilities, streamlining the design of devices that need both data points for secure, location-based access.

Together, these GPS receivers and altimeters provide the precise, real-time geographic and altitude information necessary for secure, conditional access based on specific locations and heights. The choice of module depends on specific requirements, such as size, power efficiency, and environment, ensuring reliable functionality across various geolocation-sensitive applications.

In the geolocation-based data decryption systems and methodologies described herein, secure hardware for hash storage is crucial for safeguarding cryptographic hashes, protecting data integrity, and enforcing location-based access controls. Trusted Platform Modules (TPMs) are specialized microcontrollers that provide isolated, tamper-resistant storage for cryptographic keys and hashes in desktop, laptop, and embedded systems. Hardware Security Modules (HSMs), used primarily in enterprise environments, are dedicated devices that store and protect sensitive data, including hashes, with robust security features and FIPS 140-2 certification, making them ideal for large-scale applications.

For mobile and personal devices, Apple's Secure Enclave and Qualcomm's Secure Processing Unit (SPU) offer isolated, hardware-backed storage for cryptographic data on iOS and Android devices, respectively, ensuring hashes are secure even if the main system is compromised. In cloud environments, AWS CloudHSM provides FIPS-compliant HSMs within Amazon's infrastructure, offering secure, scalable hash storage integrated with other AWS services. For portable, user-controlled applications, Ledger hardware wallets offer tamper-resistant storage outside of traditional computing systems, useful in scenarios where portable high-security hash storage is needed.

Additionally, Intel Software Guard Extensions (SGX) provides a secure enclave within Intel processors, isolating sensitive data and preventing unauthorized access, making it suitable for secure hash storage in Intel-based systems. Together, these secure hardware options provide versatile, reliable hash storage solutions across various platforms and deployment environments, ensuring robust protection for cryptographic data in geolocation-sensitive applications.

In the geolocation-based data decryption systems and methodologies disclosed herein, specialized software to interpret GPS and altitude data is crucial for applying location-based access controls. GeoServer, an open-source platform for geospatial data, offers real-time data analysis and geofencing, making it ideal for enterprise systems managing multiple secure access zones. Similarly, the Google Maps API provides real-time GPS and altitude verification and is well-suited for mobile and web applications requiring fast and reliable geolocation data. Mapbox also offers flexible geofencing tools, allowing developers to build custom location-based rules for mobile and IoT devices.

For larger-scale applications needing advanced geographic information system (GIS) capabilities, ESRI ArcGIS provides detailed spatial analysis, supporting complex, multi-floor or multi-region access controls in secure facilities. AWS Location Service integrates seamlessly with Amazon's cloud infrastructure, enabling scalable location-based access within the AWS ecosystem, while HERE Location Services offers precise 3D geofencing, ideal for automotive, IoT, and multi-level building applications. OpenLayers, an open-source JavaScript library, enables GPS data interpretation and interactive mapping for web applications needing flexible geofencing and altitude verification.

These tools support the system's location-based access requirements by accurately interpreting GPS and altitude data and enforcing location-specific restrictions. Each solution offers unique advantages in terms of platform compatibility, scalability, and precision, making it possible to implement secure, real-time data access control across various applications and environments.

In the geolocation-based data decryption systems and methodologies disclosed herein, access condition metadata defines the precise criteria for when and where encrypted data can be accessed, enabling the system to restrict access to authorized users at specified locations. Geographic coordinates (latitude and longitude) and altitude data preferably serve as core metadata elements, specifying the precise location, including floor or level in a multi-story building. To accommodate GPS variability, a geofencing radius and proximity tolerance threshold can add flexibility, creating a defined area around the coordinates and allowing minor deviations while still maintaining strict access controls.

Additional metadata such as time-based conditions further refines access, limiting availability to specific hours or dates, which is useful for scenarios like scheduled meetings or time-sensitive information. Device identifiers and user authentication tokens add layers of security by ensuring that access is granted only to pre-approved devices and authenticated users within the authorized location. Environmental conditions, including parameters like ambient temperature or light levels, add context-sensitive access controls for specific environments, such as secure labs where controlled conditions are essential.

The system can also use access logs and history to track previous access attempts, allowing it to detect unusual patterns or suspicious behavior, like repeated access attempts within a short time frame. For applications requiring a high degree of precision, orientation or facing direction metadata may specify the device's orientation, adding further granularity to the geolocation-based access controls. Collectively, these metadata elements allow the system to enforce highly detailed, multi-layered access conditions that restrict data access based on a combination of physical location, device specifications, time, and environmental factors.

In the geolocation-based data decryption systems and methodologies disclosed herein, a variety of location-determining technologies provide the precise geographic and altitude data necessary for enforcing secure access controls. GPS is widely used for outdoor applications, offering high accuracy through satellite positioning, while Wi-Fi Positioning Systems (WPS) are effective indoors, where GPS signals can be unreliable. Bluetooth Low Energy (BLE) beacons allow for fine-grained, room-level accuracy, particularly valuable in multi-story buildings or within specific facility areas. In situations where GPS or Wi-Fi may not be available, cellular triangulation provides a useful fallback, estimating location based on signal strength from nearby cell towers, making it well-suited for urban and suburban locations.

For high-precision indoor positioning, Ultra-Wideband (UWB) offers centimeter-level accuracy, making it ideal for tracking in secure facilities. Inertial Measurement Units (IMUs) complement GPS and WPS by tracking movement and estimating position changes, ensuring continuous location data in transition areas where signal strength may fluctuate. For proximity-based access, RFID technology is particularly effective, detecting when authorized individuals or devices enter specific checkpoints within restricted areas. Finally, LiDAR provides detailed, 3D spatial mapping, useful in environments with structural obstacles that may interfere with other signals. Together, these technologies enable the system to provide secure, location-based access across a range of environments, ensuring data protection and precise access control based on geographic position.

In the geolocation-based data decryption systems and methodologies disclosed herein, secure communication channels are essential for transmitting sensitive location and access request data. These channels ensure data integrity and confidentiality by providing encryption and authentication across different network environments. Transport Layer Security (TLS) is widely used in web and mobile applications, offering strong encryption and compatibility for secure transmission of location data over the internet. For enterprise applications, Virtual Private Networks (VPNs) create encrypted tunnels that protect data from interception, making them ideal for transmitting access requests over public networks. Secure Shell (SSH) is another robust option, often used for secure, direct device-to-server communication, particularly in IoT applications requiring encrypted remote access.

Secure WebSockets (WSS) provides low-latency, continuous communication over TLS, suitable for real-time applications where location updates are frequently transmitted. For messaging and IoT applications, Advanced Message Queuing Protocol (AMQP) with SSL/TLS encryption ensures reliable and encrypted data exchange, which is ideal for secure message delivery in distributed systems. For close-proximity data transmission, Bluetooth Low Energy (BLE) with secure connections enables encrypted, low-power communication, while Zigbee with application layer encryption offers similar security for IoT devices within smart buildings or industrial setups. Additionally, cellular data encryption with IPsec secures data transmission over mobile networks, making it a suitable option for field-based applications that transmit location data over cellular connections. Each of these channels provides secure data transfer tailored to specific use cases, ensuring the inventive system maintains reliable protection for location-sensitive information.

In the geolocation-based data decryption systems and methodologies disclosed herein, multi-factor authentication (MFA) software provides an essential security layer, ensuring only authorized users can access data within specified locations. Microsoft Azure Active Directory (Azure AD) MFA offers cloud-based authentication with options like mobile app notifications, passcodes, and biometrics, making it ideal for enterprise settings requiring integration with Microsoft services and geolocation-based access policies. Similarly, Duo Security by Cisco provides flexible MFA options, including adaptive authentication that adjusts security requirements based on user behavior and location, which is particularly suited for remote access and high-security environments.

Okta MFA supports a range of factors like push notifications and contextual access management, enabling location-based controls that integrate seamlessly with cloud applications and enterprise systems. Google Authenticator, while simpler, offers time-based one-time passcodes (TOTP) through a mobile app, providing an effective, low-cost solution for two-factor authentication. Authy by Twilio extends this functionality with multi-device access and synchronization, making it useful for users needing secure, cross-device access in field-based applications.

For high-security requirements, RSA SecurID delivers robust authentication options, including hardware tokens and biometrics, which are suitable for government and financial applications. Lastly, Ping Identity MFA combines push notifications, biometrics, and adaptive authentication, enabling dynamic, location-aware access control. Each of these MFA solutions enhances security within the system, allowing administrators to enforce multi-layered access verification based on location, device type, and user behavior, thereby providing tailored authentication that meets the needs of various high-security, location-sensitive environments.

In the geolocation-based data decryption systems and methodologies disclosed herein, hash comparison software is essential for securely verifying that a user's location-based hash matches the predefined access hash, ensuring access is only granted under authorized conditions. Several robust software options provide this functionality across different environments. OpenSSL is a widely-used open-source cryptographic library that supports a range of secure hashing algorithms like SHA-256 and SHA-3, making it highly suitable for diverse applications, from web platforms to embedded systems. Similarly, Bouncy Castle, with its extensive algorithm support, offers flexibility for hash comparison in Java and .NET environments, allowing secure, customizable implementations. For performance-critical or low-level control, Crypto++ (CryptoPP) provides optimized cryptographic functions and is ideal for real-time and embedded systems requiring efficient hash comparisons.

On Windows, Microsoft Cryptography API: Next Generation (CNG) integrates seamlessly with the OS's security infrastructure, offering a streamlined, system-level approach for secure hash storage and comparison. In cloud-based systems, AWS Key Management Service (KMS) paired with AWS Lambda provides scalable, secure hash comparisons, enabling cloud-native applications to perform custom hash operations on demand. Libgcrypt, commonly used in Linux-based and embedded environments, is efficient and well-suited for resource-constrained devices like IoT systems, while Google Tink offers a straightforward, cross-platform API for secure hash comparison, ideal for mobile, cloud, and web applications needing easy-to-integrate cryptographic support.

These libraries enable precise and secure hash comparisons across a range of applications, ensuring reliable enforcement of location-based access criteria. By offering varied functionality and integration options, each library supports the system's need for robust cryptographic verification to protect data in geolocation-sensitive applications.

In the geolocation-based data decryption systems and methodologies disclosed herein, logging software is essential for tracking access attempts and generating alerts for potential unauthorized activities, ensuring comprehensive security monitoring. Splunk is a powerful logging and monitoring platform known for its scalability and ability to handle large data volumes, making it ideal for enterprise applications that require detailed tracking of access patterns and anomaly detection. Similarly, LogRhythm provides a centralized, real-time security information and event management (SIEM) system, well-suited for applications that demand rapid incident response and detailed monitoring of geolocation-based access.

For open-source and cost-effective solutions, Graylog offers centralized log management with robust search and alert capabilities, allowing organizations to tailor monitoring to their needs. Cloud-native applications benefit from AWS CloudTrail, which seamlessly integrates with other AWS services to track and alert on user activity, including access attempts. Another powerful choice, the Elastic Stack (ELK Stack)—comprising Elasticsearch, Logstash, and Kibana—enables real-time analysis and visualization of access logs, providing a highly customizable and scalable logging solution.

Sentry is commonly used in web and mobile applications to monitor real-time access patterns and detect anomalies, making it a good fit for applications that require immediate visibility into user interactions. For cloud-based and hybrid applications, Datadog combines monitoring and logging with real-time alerts and anomaly detection, offering detailed insights into access behaviors. Additionally, Microsoft Azure Monitor integrates with Azure's suite of services to provide detailed tracking and alerting within the Azure ecosystem, supporting applications that leverage Azure's cloud infrastructure. Each of these logging tools supports robust access tracking and quick response to unauthorized access, helping maintain data integrity and security in systems requiring precise location-based access control.

In the geolocation-based data decryption systems and methodologies disclosed herein, secure key distribution software is essential for safely managing cryptographic keys, ensuring they are accessible only to authorized users within specific locations. AWS Key Management Service (KMS) offers a cloud-native, scalable solution that integrates with AWS security policies, automating key rotation and enforcing location-based access controls for applications within the AWS ecosystem. Similarly, Microsoft Azure Key Vault and Google Cloud KMS provide secure key storage and distribution within the Azure and Google Cloud platforms, respectively, enabling seamless integration with geolocation-based policies. For applications in regulated industries requiring FIPS-compliant security, IBM Cloud Hyper Protect Crypto Services provides a highly secure, hardware-backed option, offering tamper-resistant key management within the IBM Cloud.

For multi-cloud and hybrid environments, Thales CipherTrust Manager and Entrust KeyControl offer centralized key management with detailed geolocation-based access policies, supporting encryption key distribution across diverse infrastructures. HashiCorp Vault is an open-source solution known for its flexibility, allowing secure key management in both cloud and on-premises deployments with robust access control and auditing features. For smaller or custom environments, OpenSSL paired with a public key infrastructure (PKI) provides cost-effective key generation and secure distribution through digital certificates. Together, these key distribution solutions offer secure, efficient, and versatile options to enforce geolocation-sensitive access controls, safeguarding cryptographic keys across various deployment environments.

In the geolocation-based data decryption systems and methodologies disclosed herein, decryption software is essential for securely interpreting encryption keys and algorithms, ensuring data access is only granted to authorized users in specified locations. OpenSSL, a widely-used open-source toolkit, supports a broad range of encryption and decryption algorithms like AES and RSA, making it versatile for diverse applications requiring reliable decryption based on conditional access. Similarly, Microsoft Cryptography API: Next Generation (CNG) offers Windows-based decryption capabilities with hardware-backed security, integrating seamlessly into enterprise environments that rely on Windows infrastructure. GnuPG (GPG), an open-source solution for public-key cryptography, provides robust decryption support, particularly for file-based encryption, and is compatible across platforms.

In cloud-native environments, AWS Key Management Service (KMS) and Google Cloud KMS deliver secure, managed decryption with integrated key management within the AWS and Google Cloud ecosystems. Both services are ideal for applications needing scalable decryption with built-in logging and auditing features. For enterprises requiring high-performance decryption, IBM's Crypto Service Adapter (CSA) offers hardware-accelerated cryptographic processing, making it suitable for regulated industries like finance and healthcare. HashiCorp Vault is another strong option for distributed and hybrid environments, offering controlled decryption and secure key management for multi-cloud setups.

For secure, file-based decryption, VeraCrypt provides strong, open-source encryption and decryption capabilities, supporting algorithms like AES, Serpent, and Twofish, and is particularly effective for local storage and individual devices. Together, these solutions provide flexible, secure decryption options across diverse deployment environments, supporting the inventive system's need for location-sensitive access control while ensuring data integrity and compliance with strict security protocols.

Some embodiments of the systems and methodologies disclosed herein may integrating Multi-Factor Authentication (MFA) based on environmental and behavioral factors. This adds a sophisticated layer of security beyond standard location-based access criteria. By incorporating contextual elements such as ambient noise, temperature, and user behavior, this enhanced MFA system verifies access based on real-world environmental cues and unique user patterns, making it much harder for unauthorized individuals to gain access.

For example, environmental conditions could include ambient noise, temperature, and humidity, which are specific to particular settings such as secure labs or controlled office environments. The system would assess these factors in real time, ensuring that they align with preset thresholds for the authorized access area. If an access request is made but the environmental factors don't match the authorized conditions (e.g., a secure server room where the ambient noise and temperature are expected to be stable), the system could deny access, alerting administrators of potential security breaches.

Behavioral factors offer another layer of security, as they rely on unique user patterns that are difficult to replicate. This could involve gait recognition, which analyzes the user's walking patterns as they move through the facility, or typing dynamics, which measures typing speed and rhythm as the user interacts with the device. These patterns are unique enough to each individual that they can serve as an effective behavioral “fingerprint.” For example, even if an unauthorized individual manages to access the correct location, they would still need to match the expected gait or typing patterns to gain full access.

This MFA approach combines environmental, behavioral, and geographic factors to create a multi-layered security model that adapts to specific environments and individual users. By requiring alignment across these factors, the system ensures access is only granted when the context matches authorized conditions precisely, reducing the likelihood of unauthorized access and increasing security resilience.

Some embodiments of the systems and methodologies disclosed herein may provide Enhanced Indoor Positioning System (IPS) compatibility. IPS compatibility would significantly improve the system's reliability and precision in indoor environments, where traditional GPS signals are often weak or unavailable. GPS typically struggles to provide accurate location data indoors, especially in large buildings or underground facilities. By integrating support for IPS technologies such as Ultra-Wideband (UWB), Bluetooth Low Energy (BLE) beacons, and Wi-Fi positioning, the system could offer room-level or even sub-room-level location accuracy, enabling more granular access control.

Ultra-Wideband (UWB) technology, known for its high precision and low interference, can determine location within a few centimeters, making it particularly effective for environments where accurate, short-range tracking is essential. UWB would be ideal in secure areas within facilities, like data centers or laboratories, where users must be in a very specific area to gain access. This precision allows the system to control access down to individual rooms, hallways, or even specific equipment zones.

Bluetooth Low Energy (BLE) beacons are another effective IPS technology for indoor positioning, especially in buildings with multiple rooms and floors. BLE beacons emit signals that mobile devices can detect, and the system can use signal strength and proximity to determine the user's location. BLE is especially valuable in large facilities where more comprehensive coverage is needed, such as corporate offices, hospitals, or warehouses. BLE can support room-specific access policies, allowing for detailed access control across different areas of a facility.

Wi-Fi positioning, which leverages existing Wi-Fi networks, can track users through signal triangulation or signal strength measurements, providing floor- and room-level accuracy. Wi-Fi positioning is particularly useful in environments with established Wi-Fi infrastructure, such as office buildings, airports, and educational institutions. The system can use Wi-Fi data to determine the user's approximate location within the building, enabling access restrictions based on floor or specific room location.

Combining these IPS technologies with traditional GPS allows for seamless transitions between indoor and outdoor tracking, ensuring consistent and accurate location verification. This hybrid approach could enable the system to manage complex access control scenarios, such as multi-floor buildings or facilities with restricted sections within the same floor. For example, a user might be granted access to a conference room on the third floor but not to the adjoining executive office. Enhanced IPS compatibility enables such precise control, ensuring that data access is tightly regulated based on highly accurate indoor positioning, ultimately improving security and access management in environments with specific location requirements.

Some embodiments of the systems and methodologies disclosed herein may implement dynamic access adjustment based on proximity. This allows the system to vary data exposure depending on the user's distance from a specified location, adding a layer of flexibility and security. This approach goes beyond simple “yes or no” access by creating tiers of data access that adjust dynamically as the user's location changes relative to the access point. By doing so, the system can enforce varying levels of data permissions within a single area, supporting use cases where full access should only be granted when the user is precisely within a designated location, while more limited or “preview” access might be allowed from a distance.

For instance, in a corporate setting, employees approaching a sensitive area like a data center might initially receive access to summary data or non-sensitive content as they come within a specified range. As they move closer to the access point—such as right outside the secured data center entrance—the system could grant additional access to intermediate information, allowing the user to prepare for their task. Full access, however, would only be granted once the user is physically within the exact coordinates of the authorized location, ensuring that the most sensitive data remains fully protected until the user is in the correct, secure position.

This proximity-based access model could also prove invaluable in healthcare environments. For example, a doctor or nurse might be granted limited patient information (e.g., general alerts or patient status summaries) when they are in the hallway, which enables them to prepare before entering the patient's room. Once they reach the patient's bedside—within a defined proximity—the system could then grant them full access to comprehensive patient records or detailed treatment plans. This ensures that sensitive health data is only fully accessible within the secure confines of the patient's immediate vicinity, enhancing patient privacy.

In research facilities or laboratories, proximity-based access control can allow scientists or technicians to view limited data summaries or project outlines when they are near an area containing sensitive materials, with full access to experimental data or equipment controls only permitted upon entry into a specific, secure zone. This allows for initial data review and preparation outside of the controlled environment, reducing unnecessary handling of sensitive information in unsecured areas.

Furthermore, proximity-based data access could be beneficial in manufacturing or logistics environments, where workers might need access to different levels of production data depending on their exact location within a facility. For instance, a worker in a staging area might have partial visibility into an upcoming production run, while a worker on the assembly line could be granted complete access to production schedules, material specifications, and real-time analytics.

By dynamically adjusting access levels based on proximity, the system enhances security, reduces unnecessary exposure of sensitive data, and tailors access to the specific needs of users at various locations within a restricted area. This approach not only strengthens data protection but also improves user efficiency by ensuring that users have the right level of information at the right time and place.

Some embodiments of the systems and methodologies disclosed herein may integrate real-time location verification with continuous monitoring. This enhances data security by ensuring that users remain within authorized zones throughout their access sessions. Unlike static, one-time location checks, continuous monitoring actively tracks the user's position in real time. This added feature allows the system to respond dynamically to any movement outside of the permitted area, helping to prevent data exposure if a user inadvertently or intentionally moves beyond the designated location.

For instance, in high-security environments such as government facilities or research laboratories, continuous location verification ensures that sensitive data can only be accessed within specific, secure locations. If a user begins an access session in a designated secure room but then moves to an adjacent, less secure area, the system could automatically restrict or suspend access, safeguarding data by preventing unintended exposure outside the secure zone. This approach is particularly valuable for facilities with stringent security requirements, where even minor deviations in location could pose security risks.

In healthcare settings, real-time location verification is important for safeguarding patient data. For example, a doctor or nurse accessing patient records at a workstation near a patient's room would lose access if they leave the immediate vicinity, ensuring that sensitive health information is not accessible from hallways or other public spaces. This approach enhances patient privacy, as medical data is only accessible within the private, designated area. If the user re-enters the authorized location, access could be automatically restored, streamlining workflows without compromising security.

In financial institutions, where employees may access highly sensitive financial data, continuous location monitoring ensures that data access is limited to specific zones within secure office areas. If an employee were to access financial records on the trading floor but then attempt to leave the restricted area, the system could instantly suspend their access. This continuous tracking helps to prevent data leaks and ensures that secure information is only viewed within the authorized premises.

For remote or hybrid work settings, continuous location verification could enable a “virtual geofence” around a user's authorized workspace, such as a home office or designated remote site. If a user with access to sensitive corporate information moves outside this defined workspace (e.g., takes a device to an unapproved location), the system could restrict data access, reducing the risk of data breaches due to unauthorized device use in public areas.

Continuous monitoring also enhances compliance with regulatory requirements, such as those in healthcare, finance, or government sectors, which may mandate strict controls over data access based on location. Real-time verification allows organizations to maintain detailed access logs, providing an audit trail that shows exactly when and where sensitive data was accessed. If an unauthorized location attempt occurs, the system can generate an alert or log the event, allowing administrators to respond quickly to potential security incidents.

By ensuring access is dynamically linked to the user's exact, real-time location, continuous monitoring minimizes the risk of sensitive data exposure, supports regulatory compliance, and strengthens overall security. This feature ensures that data access is not only based on initial location checks but is actively managed throughout the session, providing a secure, adaptable solution that responds to users' movements in real time.

Some embodiments of the systems and methodologies disclosed herein may utilize adaptive encryption techniques. Secure data transmission using adaptive encryption techniques enhances security by dynamically adjusting encryption levels based on the user's distance from a central access point, creating a responsive, context-aware approach to data protection. This adaptive encryption model can be particularly valuable in high-security environments where data must be shielded against potential interception as it travels across networks. By increasing encryption strength based on proximity, the system provides an additional layer of defense against unauthorized access, eavesdropping, and other cyber threats.

In adaptive encryption, the system determines the user's location relative to a central, secure access point, such as a corporate data center, secure server, or authorized workplace. For users close to this central point (such as within a secure room), the system may use a standard encryption protocol, ensuring data remains protected while enabling quick access. However, as the user's distance from this access point increases—whether they are moving to a more remote location within a large facility or accessing data remotely from another branch or home office—the system can increase the encryption strength. For instance, it could shift from AES-128 to AES-256 or implement multi-layered encryption techniques, ensuring that data transmission remains secure even over potentially vulnerable or longer-distance network paths.

In practical terms, adaptive encryption is beneficial in scenarios like field-based data access, where employees or contractors need to access sensitive information from off-site locations. As the distance from the central data source grows, so does the risk of interception, especially if the data travels over public or shared networks. By increasing the encryption level based on distance, the system can counteract these risks, making it significantly harder for unauthorized parties to decrypt intercepted data. For example, employees accessing data from a corporate campus could experience a moderate encryption level, while remote employees or contractors accessing the same data from an unsecured location would experience an intensified, multi-layered encryption protocol, ensuring robust protection across varying network environments.

In healthcare, adaptive encryption could be used to protect sensitive patient information accessed by doctors who may need to view records both within hospital premises and off-site at partner clinics or remote consultation centers. When doctors access data within the hospital, standard encryption ensures security while maintaining efficiency. However, if they access the same data remotely, adaptive encryption would intensify, using stronger protocols to safeguard patient records against unauthorized access over public networks.

Adaptive encryption could also apply to mobile workforce scenarios in logistics or construction, where employees need access to project data across large, multi-location job sites. As they move from secure, on-site access points to remote areas of the job site, the encryption level could automatically increase, reflecting the additional risk in these less-controlled environments. This approach could prevent data vulnerabilities from arising when employees move to remote sections of the site or when connecting to less secure mobile networks.

In financial services, where secure data transmission is important, adaptive encryption could add a further layer of defense against data breaches. For example, financial advisors accessing client portfolios within a corporate office may work with a standard encryption level, but if they access the same data off-premises, the system could automatically increase the encryption strength to account for the heightened exposure risk, particularly if advisors are using public or shared Wi-Fi networks.

The adaptive encryption technique could also include an automated audit trail, which logs changes in encryption strength based on user location and access point proximity. This logging feature would provide valuable information for compliance and auditing purposes, showing that higher encryption was automatically applied as users accessed data from increasingly distant or unsecured locations.

Overall, adaptive encryption based on proximity provides a flexible, location-sensitive layer of security that enhances data protection during transmission. It ensures that data remains strongly encrypted and resilient against attacks, regardless of the access location, making it particularly valuable for organizations that handle highly sensitive information across varied and dynamic environments.

Some embodiments of the systems and methodologies disclosed herein may implement user and device authentication based on historical patterns. This leverages machine learning and behavioral analytics to establish a baseline of typical access behaviors, enabling the system to detect anomalies that could indicate unauthorized access attempts. By continuously analyzing historical data—such as previous access locations, times, devices, and behaviors—the system can build a comprehensive profile for each user and device, learning to distinguish between normal and suspicious activities. This advanced approach not only strengthens security but also provides an adaptable, context-aware mechanism that evolves with the user's behavior over time.

For instance, the system could learn that a particular employee typically accesses sensitive data from a secure company office using a specific device, at regular times each day. If, however, an access attempt occurs outside of these parameters—such as late at night, from an unfamiliar device, or from a new geographic location—this deviation from the established pattern could trigger an alert or require additional verification steps. The system might prompt for an additional authentication factor, such as a biometric scan or a one-time passcode, to confirm that the access attempt is legitimate. This adaptive approach enhances security by ensuring that only trusted users with verified behaviors are granted access.

Incorporating historical access patterns also allows the system to detect subtler forms of unusual activity. For example, it could track whether a user's access location has gradually shifted over a short period, which may indicate that a device is being moved out of a secure area. Such a change might signal a potential breach, prompting the system to restrict access temporarily or notify administrators to investigate further. Additionally, by monitoring device characteristics, the system can recognize if a previously authenticated device has suddenly changed its settings or configuration (e.g., a new IP address or operating system), which may be an indication of a compromised device.

The system can also track variations in user behavior, such as access speed, navigation patterns, or data retrieval methods. For example, if a user who typically accesses only a few files suddenly begins downloading large volumes of data, the system could interpret this as a possible security risk and limit data exposure until the activity is verified. Similarly, if an employee who usually works from a single building or location initiates an access request from a foreign country or an unusual region, the system might initiate an additional verification process, as this could indicate an attempted security breach.

Anomaly detection based on historical patterns is particularly useful in detecting credential-based attacks, where an unauthorized person may have acquired a user's login information. Even if they have the correct credentials, their behavior and access patterns may differ significantly from those of the legitimate user. For instance, if a hacker logs in from an unusual location, at an atypical time, or exhibits access behavior that deviates from the established norm, the system's anomaly detection feature could identify this as high-risk activity and act accordingly.

For organizations with remote workforces, historical pattern analysis provides an added layer of security by adapting to users' regular routines while still identifying unusual behavior. If an employee typically works from a designated home office location, but an access attempt is detected from a new, unapproved location, the system can recognize this deviation as a potential security risk. This approach minimizes disruption to legitimate users while remaining sensitive to potential threats posed by compromised credentials or unauthorized access attempts.

By actively learning from and adapting to each user's unique access patterns and device characteristics, the system not only improves security but also reduces false positives. As the system collects more data over time, it can refine its understanding of normal behaviors, enabling it to respond to security risks more effectively and with greater precision. This historical pattern-based authentication adds a dynamic, intelligent layer to traditional security methods, allowing organizations to proactively prevent unauthorized access while maintaining efficient and seamless access for legitimate users.

Some embodiments of the systems and methodologies disclosed herein may integrate biometric verification with location-based access control. This adds an essential layer of security to the system, enhancing its ability to verify not only where the access attempt is taking place but also confirming the identity of the individual requesting access. This dual approach is particularly valuable in high-security environments, where ensuring that the correct, authorized person is accessing data from the correct, secure location is crucial. By combining these verification methods, the system can achieve more robust access control, reducing the risks associated with location-only or biometric-only authentication.

For instance, fingerprint recognition can be used alongside location-based access to ensure that only approved individuals within a secure facility can access highly sensitive data. If an employee needs access to a secure database in a classified section of a corporate office, the system would first verify that the device is located within the correct, geofenced area. Once this condition is met, the system could then require a fingerprint scan before granting access, ensuring that both location and identity are verified. This approach would prevent unauthorized individuals from accessing sensitive information even if they manage to physically enter the restricted area or gain temporary possession of an approved device.

Facial recognition offers another secure biometric option that can be seamlessly integrated with location-based access, especially for hands-free access scenarios or in settings where frequent reauthentication is necessary. For example, a user working in a high-security lab may need to move between different rooms, accessing various devices and data terminals. With facial recognition integrated into each access point, the system can authenticate the user without requiring repeated login credentials or device access codes. This process allows for a smooth workflow while ensuring that only the approved individual has access, even if the device is left unattended in an authorized area.

Voice recognition could also serve as an effective biometric in combination with location data, particularly in environments like command centers or healthcare facilities where employees need fast, secure access to information. When an authorized user in a geofenced location speaks a designated passphrase, the system verifies both their voiceprint and their proximity to the central access point, allowing for quick and secure access to sensitive data without physical interaction with the device. This can enhance productivity in hands-free work environments while maintaining a high level of security.

Behavioral biometrics, such as keystroke dynamics and gait recognition, could also be used to augment location-based access. Keystroke dynamics analyze typing patterns that are unique to each user, while gait recognition identifies individuals based on their unique walking patterns. For instance, the system could require keystroke analysis for users logging into sensitive applications, even within authorized locations. Gait recognition could verify individuals as they move through secure areas within a facility, restricting access to certain zones unless the gait pattern matches the authorized user profile. These biometric features provide continuous verification, enhancing security beyond the initial access point.

By integrating biometric verification with location-based access, the system addresses potential vulnerabilities associated with location-based access alone, such as instances where a device could be carried into a secure area by an unauthorized person. Even if the device is correctly positioned within the approved geofenced area, biometric checks ensure that only the right person can access data, adding a secondary authentication layer that deters unauthorized access. In high-security applications, this dual-factor approach not only increases security but also helps organizations comply with stringent regulatory requirements for data protection.

The combination of biometrics with geolocation provides an adaptive security model that offers flexibility across various access scenarios. For instance, in areas with moderate security needs, only location-based access may be required, while high-security zones could enforce both location and biometric verification. This tiered approach allows organizations to allocate security resources efficiently, applying additional verification only where it is most needed. By dynamically adjusting authentication requirements based on both the user's location and identity, the system can maintain seamless yet secure access across diverse operational environments.

Ultimately, integrating biometric authentication with location-based access delivers a high-assurance solution that significantly enhances data protection. It ensures that access is restricted to authorized individuals at specific locations, effectively combining “who” and “where” factors to safeguard sensitive information, streamline secure access, and support compliance with high-security standards.

Some embodiments of the systems and methodologies disclosed herein may incorporate time-restricted and context-aware access control into the geolocation-based data access system. Doing so adds an extra dimension of security, ensuring that access to sensitive data is allowed only during specific, authorized periods. By setting time-based restrictions in conjunction with location criteria, the system can grant or deny access based on predefined timeframes, thereby protecting time-sensitive or confidential data from unauthorized access outside permitted hours. This combination of time and location factors ensures that data is accessible only when and where it is truly needed, effectively reducing the window of exposure to potential threats.

For instance, in a corporate setting, access to sensitive financial data or strategic documents could be restricted to regular working hours, such as 9 a.m. to 6 p.m., to prevent unauthorized after-hours access. Employees who attempt to access this data outside of these hours, even from approved locations, would be denied, helping prevent unauthorized access by cleaners, contractors, or unauthorized employees who may be in the building after hours. Time-based restrictions can also extend to specific days, allowing access only on weekdays or during designated project periods, effectively enforcing both a physical and temporal security boundary.

Time-based access control is especially useful in highly regulated industries, such as healthcare, finance, and government, where sensitive data must be protected from unauthorized access both inside and outside of the workplace. For example, access to a hospital's patient management system could be restricted to clinicians and staff only during their scheduled shifts. This way, if an employee attempts to access patient records outside their shift hours, the system would recognize the discrepancy and deny access, thereby protecting patient privacy. Similarly, in government facilities, classified documents could be accessible only during official working hours, adding an additional layer of security that aligns with the organization's operational requirements.

Additionally, context-aware access control adds further granularity by incorporating elements like time of day and calendar-based permissions. This approach could include adjusting access based on specific meeting times, project deadlines, or seasonal factors, thereby allowing finer control over data access. For example, access to an internal server containing a project's confidential files could be limited to employees during the hours of a scheduled project meeting. By aligning access with scheduled events or project timelines, the system ensures that data exposure is minimized to relevant timeframes and aligned with real-time operational needs.

For organizations with global teams or employees who work flexible hours, context-aware access control can take into account time zone differences or approved working hours per user profile. A remote employee based in a different time zone could have access to sensitive data only during their designated working hours, regardless of their physical location. This approach ensures that employees working unconventional hours have access only when they are scheduled to work, reducing the risk of unauthorized data access during off-hours while respecting the global nature of the organization's workforce.

To further enhance security, the system could combine time-restricted and location-based access with environmental or behavioral conditions, making access even more context-sensitive. For example, an employee accessing sensitive data at an authorized location during approved hours may still need to meet additional conditions, such as using a pre-registered device or undergoing biometric verification. If any of these conditions are unmet, the system could restrict access, even if the time and location criteria are satisfied. This multi-layered, context-aware approach ensures that only the right person, at the right time and place, using the right device, can access sensitive information.

This time-sensitive and context-aware access model also enables a more nuanced, tiered approach to data protection. Less important data could be accessible around the clock, while highly sensitive data could have tighter restrictions, accessible only during working hours in specific areas. This approach allows organizations to allocate security resources according to data sensitivity, aligning data access with operational needs while protecting against unauthorized access.

By expanding the system to consider both time and contextual factors alongside location, organizations achieve a highly controlled, flexible security solution. It allows them to dynamically adjust access permissions in response to evolving security requirements, operational changes, and employee needs, ultimately supporting a more adaptive, responsive approach to securing sensitive data.

Some embodiments of the systems and methodologies disclosed herein may implement decryption fail-safe mechanisms. This introduces a proactive layer of security that enhances the overall integrity of the system by closely monitoring and managing decryption attempts. These mechanisms are designed to log unsuccessful attempts, restrict further attempts after a certain threshold, and notify administrators in real-time, thereby providing early detection and response to potential unauthorized access. By automatically logging each decryption attempt, the system establishes a detailed audit trail, allowing administrators to track patterns in access behavior, identify potential threats, and ensure compliance with security protocols.

One key component of this approach is the restriction of further decryption attempts after a predefined number of failures. For instance, if a user fails to decrypt a data file after three attempts, the system could automatically lock access to that file for a predetermined period or require administrator intervention before allowing additional attempts. This temporary restriction limits the effectiveness of brute-force attacks, in which an unauthorized individual might attempt to guess decryption keys or credentials. By enforcing these limitations, the system significantly reduces the risk of unauthorized decryption, making it harder for attackers to gain access even if they have initial access to the system.

In addition to restricting repeated failures, the system could trigger real-time alerts to administrators whenever a threshold is reached, such as a predefined number of failed decryption attempts within a certain timeframe. This alerting feature enables security teams to respond quickly, investigating the source of the failed attempts to determine whether they are due to a simple user error, such as mistyped credentials, or if they indicate a more serious threat. By flagging unusual decryption behavior, such as repeated attempts from a single device or user profile, the system can help administrators quickly identify and address suspicious activity before it escalates.

Beyond immediate notifications, decryption fail-safe mechanisms can incorporate adaptive security measures, such as requiring additional verification for reattempts after failures. For instance, if a user fails to decrypt a file multiple times, the system could require multi-factor authentication (MFA) for subsequent attempts, adding another layer of security. This additional verification step ensures that even if someone gains unauthorized access to the system, they would face heightened barriers before being able to attempt further decryption. This adaptive approach tailors the response to the perceived risk level, thereby balancing security with user accessibility.

For highly sensitive data, the system could escalate fail-safe mechanisms by permanently locking the file after a series of failed attempts until reviewed and reset by an administrator. This level of restriction ensures that data remains secure under strict circumstances, allowing only authorized personnel to assess the situation and restore access. Such a lockout mechanism is valuable for data that requires exceptionally high security, as it prevents access even to authorized users until the issue is resolved, protecting the information from potential compromise.

Additionally, the fail-safe system could provide automated incident reports that detail each failed attempt, the timing, and associated user credentials or device information. These reports enable administrators to review failed attempts in context, assessing whether there is a consistent pattern of suspicious activity or if the failures stem from benign causes. The collected data can also feed into security analytics, providing insights that help the system learn and adapt, strengthening its ability to detect and mitigate future unauthorized access attempts.

By implementing these fail-safe mechanisms, organizations can achieve a responsive and resilient security framework that not only safeguards sensitive information but also deters unauthorized access attempts. This proactive approach to managing decryption activity reinforces data security, giving administrators powerful tools to detect, analyze, and respond to threats in real time, while maintaining a thorough record of access attempts for compliance and auditing purposes.

Some embodiments of the systems and methodologies disclosed herein may provide enhanced privacy controls for multi-user access environments. Such controls may be essential for maintaining data security and confidentiality when multiple users access data within the same physical location. In shared environments, such as corporate offices, hospitals, or research labs, different users may require access to distinct segments of data while ensuring other parts remain restricted according to their specific roles or security clearances. By adding privacy controls that segregate data based on user credentials, location, and permissions, the system can deliver precise access tailored to each user's authorization level, enhancing security and supporting compliance in multi-user settings.

One approach to implementing these enhanced privacy controls is through role-based access segmentation. For instance, in a corporate setting, employees in different departments-such as finance, HR, and operations-could access a shared system but see only the data relevant to their roles. A finance manager could access financial records while an HR representative could view employee information, each restricted to their department's dataset. Role-based segmentation thus ensures data privacy across departments and reduces the risk of unauthorized access to sensitive information.

Another effective method is location-based data segmentation, which restricts access to data based on users' exact physical locations within a shared area. For example, in a hospital, patient data may be accessible in secure areas of the building, but privacy controls could limit the exact information available based on location. Physicians accessing data from patient rooms could have broader access to detailed records, while other healthcare staff, like administrative personnel, would view only essential, high-level information from a general work area. This prevents unnecessary exposure of sensitive patient data, enhancing privacy even within secure zones.

User-specific permissions can further refine privacy control by associating granular data access permissions with individual user credentials. In a research facility, for example, each researcher's access to data could be customized based on project involvement or security clearance. This way, senior researchers could have full access to experimental data and ongoing results, while junior researchers might only see summarized findings or specific datasets. User-specific permissions also provide flexibility to adjust access levels dynamically, supporting temporary access for project-based collaborations while maintaining overall data security.

For organizations where hierarchical access levels are necessary, enhanced privacy controls can implement layered access models within a shared environment. In a government agency handling classified information, different levels of clearance (such as Confidential, Secret, and Top Secret) could determine what data segments are visible to users within the same facility. Employees with higher clearances could access broader data sets, while others would see only the information within their clearance level, even if they are physically present in the same area.

Privacy controls can also incorporate context-sensitive restrictions that adjust based on user behavior and access patterns. For instance, in a collaborative workspace where multiple users need temporary access to shared data, the system could allow view-only access, preventing download or modification. In educational settings, professors and students may share access to course materials, but privacy controls could restrict certain materials, such as exams or grading data, only to faculty accounts.

Additionally, data tagging and labeling can be used to mark specific data segments with access restrictions based on content sensitivity. In legal environments, for example, client data or privileged communications could be tagged to restrict viewing to specific attorneys or caseworkers. This would ensure that only authorized personnel can access highly sensitive segments, providing an extra layer of privacy control based on data classification and content sensitivity.

Enhanced privacy controls also contribute to auditability and compliance by maintaining a detailed log of access attempts and data interactions for each user. In regulated industries, such as finance or healthcare, where data privacy regulations (like GDPR or HIPAA) require strict control over data access, these privacy controls provide a robust framework for compliance. Auditing capabilities enable administrators to review who accessed what data, from which location, and under which credentials, ensuring adherence to privacy standards and facilitating compliance reporting.

By implementing these privacy controls, the system can securely support diverse access needs within shared environments, ensuring data segregation and personalized permissions without compromising security. This multi-layered approach allows organizations to protect sensitive data while maintaining the flexibility necessary for collaborative, multi-user settings, ultimately providing a tailored, secure, and compliant data access experience across varied use cases.

The above description of the present invention is illustrative and is not intended to be limiting. It will thus be appreciated that various additions, substitutions and modifications may be made to the above described embodiments without departing from the scope of the present invention. Accordingly, the scope of the present invention should be construed in reference to the appended claims. For convenience, some features of the claimed invention may be set forth separately in specific dependent or independent claims. However, it is to be understood that these features may be combined in various combinations and sub-combinations without departing from the scope of the present disclosure. By way of example and not of limitation, the limitations of two or more dependent claims may be combined with each other without departing from the scope of the present disclosure.

What is claimed is:

1. A method for conditional access to encrypted data based on geographic location, comprising:
generating an encrypted data file for secure information storage;
associating the encrypted data file with a geolocation-based access condition, said access condition defined by a first set of geographic coordinates and a first altitude;
generating and storing a unique access hash based on the access condition;
receiving a request to decrypt the data file at a target location defined by a second set of geographic coordinates and a second altitude;
generating a target location hash based on the target location;
comparing the access hash and the target location hash; and
decrypting the data file if the target location hash matches the access hash within a predefined threshold.

2. The method of claim 1, further comprising:
decrypting the data file only if the target location hash matches the access hash within a predefined threshold.

3. The method of claim 1, wherein the altitude is specified as a floor level within a multi-story building, calculated based on a defined altitude range.

4. The method of claim 1, further comprising applying time-based constraints, wherein access to the decrypted data file is permitted only within a defined time window.

5. The method of claim 1, wherein the geographic coordinates include latitude and longitude values, and the altitude is defined as a relative distance from sea level.

6. The method of claim 1, further comprising dynamically updating the unique access hash to permit temporary changes in the access location while maintaining geographic and altitude constraints.

7. The method of claim 1, wherein the data file remains encrypted and inaccessible when the device fails to meet both the geolocation and altitude-based conditions.

8. The method of claim 1, wherein the decryption key is dynamically generated at the target location and destroyed after the defined access session.

9. The method of claim 1, further comprising an alert system that notifies an authorized administrator of any attempted access requests that fail to meet the geographic or altitude conditions.

10. The method of claim 1, wherein the access conditions are encrypted within the data file's metadata to prevent tampering or unauthorized alterations to the geographic and altitude-based constraints.

11. The method of claim 1, wherein the geolocation-based access condition is configured to allow different data access levels depending on the distance from the intended access location, such that proximity to the geofence boundary impacts data accessibility features.

12. The method of claim 1, wherein generating the encrypted data file includes encrypting the data file using a symmetric encryption algorithm to ensure data confidentiality.

13. The method of claim 1, wherein generating the encrypted data file includes using an asymmetric encryption algorithm, wherein a public key encrypts the data file, and a private key decrypts it.

14. The method of claim 1, further comprising encrypting the data file with a unique encryption key generated based on the geographic coordinates and altitude associated with the access condition.

15. The method of claim 1, wherein generating the encrypted data file includes segmenting the data into multiple encrypted portions, each segment associated with individual geolocation-based access conditions.

16. The method of claim 1, further comprising compressing the data file prior to encryption to optimize storage and improve the efficiency of the encryption process.

17. The method of claim 1, wherein generating the encrypted data file includes applying a hash-based integrity check to detect any unauthorized modifications to the data file before decryption.

18. The method of claim 1, wherein generating the encrypted data file involves storing metadata about the encryption process within the data file, including details on the encryption algorithm, key length, and access conditions.

19. The method of claim 1, wherein generating the encrypted data file includes encoding a unique identifier within the file to facilitate tracking and audit trails for data access.

20. A system for conditional access to encrypted data based on geographic location, comprising:
an encryption module configured to generate an encrypted data file for secure information storage;
an access condition module configured to associate the encrypted data file with a geolocation-based access condition, said access condition defined by a first set of geographic coordinates and a first altitude;
a hash generation module configured to generate and store a unique access hash based on the access condition;
a location-determining module configured to determine a target location defined by a second set of geographic coordinates and a second altitude;
a target location hash module configured to generate a target location hash based on the target location;
a comparison module configured to compare the access hash with the target location hash; and
a decryption module configured to decrypt the data file if the target location hash matches the access hash within a predefined threshold.
